(19) United States
(12) Patent Application Publication
(10) Pub. No.: US 2014/0207357 A1
(43) Pub. Date: Jul. 24, 2014

(54) VEHICLE-SIDE SYSTEM

(71) Applicants: Mitsuo Shimotani, Tokyo (JP); Hidehiko Ohki, Tokyo (JP); Makoto Mikuriya, Tokyo (JP)

(72) Inventors: Mitsuo Shimotani, Tokyo (JP); Hidehiko Ohki, Tokyo (JP); Makoto Mikuriya, Tokyo (JP)

(73) Assignee: MITSUBISHI ELECTRIC CORPORATION, Tokyo (JP)

(21) Appl. No.: 14/237,489

(22) PCT Filed: Nov. 10, 2011
(86) PCT No.: PCT/JP2011/075914

§ 371 Date: Feb. 6, 2014

(51) Int. Cl. B60K 31/00

(52) U.S. Cl. CPC B60K 31/00
USPC 701/93

(57) ABSTRACT

The present invention aims to provide a vehicle-side system capable of enhancing convenience for drivers who are driving vehicles having an auto-cruise function. A vehicle-side system of the present invention is mounted on a vehicle having an auto-cruise function and is capable of receiving traffic conditions from outside the vehicle. The vehicle-side system includes a position detector that detects vehicle position information that is information regarding the position of the vehicle, a receiver that receives traffic conditions, an auto-cruise setting unit that makes settings including a setting of a predetermined speed at which the auto-cruise function causes the vehicle to travel, and a controller that performs control to change the settings made by the auto-cruise setting unit on the basis of the traffic conditions received by the receiver, the settings in the auto-cruise setting unit, and the vehicle position information detected by the position detector.

### TECHNICAL FIELD

The present invention relates to a vehicle-side system that is mounted on a vehicle having an auto-cruise function and is capable of receiving traffic conditions from a center-side system.

### BACKGROUND ART

A probe information system including probe vehicles and a center-side system has currently been proposed, the probe vehicles acquiring and uploading traffic information regarding roads on which the vehicles are traveling, and the center-side system (for example, traffic condition service system) transmitting (distributing), to each vehicle, traffic conditions including traffic congestion information based on the traffic information uploaded by the probe vehicles. With this technique, each vehicle that has received the traffic conditions from the center-side system can search for and display an appropriate route on the basis of the traffic congestion information and consequently can arrive at a destination, for example, in a shorter time. Currently, probe vehicles are applied only to some vehicles such as vehicles used for telematics services of automobile manufactures, buses, and taxis, but it is expected that probe vehicles will be used as common vehicles in the future.

As a technique using traffic conditions to search for a route by, for example, Patent Literature 1 discloses a technique in which a route obtained by search based on statistical traffic information, predicted traffic information and real-time traffic information is displayed.

As a technique for a vehicle to control itself using traffic conditions, for example, Patent Literature 2 discloses a technique in which in order to alleviate discomfort felt by passengers due to a rapid change in acceleration when the vehicle is accelerated and then immediately decelerated during road travel, the vehicle speed is smoothly controlled by predicting the heading direction of the vehicle. Also, Patent Literature 3 discloses a technique in which either traffic congestion is detected or determination is made as to whether or not traffic congestion has occurred by receiving traffic congestion information, and at the time of traffic congestion, follow-up control is activated according to the conditions of the traffic congestion, and when the traffic congestion is cleared up, the follow-up control is deactivated.

### PRIOR-ART DOCUMENTS

### Patent Documents

[Patent Document 1] Japanese Patent Application Laid Open Gazette No. 2010-276396A

[Patent Document 2] Japanese Patent Application Laid Open Gazette No. 2004-322764A

[Patent Document 3] Japanese Patent Application Laid Open Gazette No. 2005-324661A

### SUMMARY OF INVENTION

### Problem to be Solved by the Invention

Although the technique disclosed in Patent Literature 1 is useful for common vehicles that travel along a route searched by a car navigation apparatus or the like, the document contains no disclosure as to application of the technique to vehicles having an auto-cruise function, and accordingly provides no convenience to drivers who are driving vehicles having an auto-cruise function.

The techniques disclosed in Patent Literatures 2 and 3 are useful in particular traveling conditions, but these documents contain no disclosure as to application of the techniques to vehicles having an auto-cruise function. With these techniques, therefore, it seems unable to provide useful information corresponding to traffic conditions to the drivers who are driving vehicles with the auto-cruise function set to ON (hereinafter also referred to as “in an auto-cruise on mode”). Also, the driver has to manually activate and deactivate the auto-cruise function according to the traffic conditions, and thus these techniques do not provide convenience to the driver.

The present invention has been conceived in view of the problems discussed above, and it is an object of the present invention to provide a vehicle-side system that can enhance the convenience for a driver who is driving a vehicle having an auto-cruise function.

### Means for Solving Problems

A vehicle-side system according to the present invention is a vehicle-side system that is mounted on a vehicle having an auto-cruise function and is capable of receiving traffic conditions from outside the vehicle, the vehicle-side system including: a position detector detects vehicle position information that is information regarding a position of the vehicle; a receiver that receives the traffic conditions; an auto-cruise setting unit that makes settings including a setting of a predetermined speed at which the auto-cruise function causes the vehicle to travel, and a controller that performs control to change the settings made by the auto-cruise setting unit on the basis of the traffic conditions received by the receiver, the settings made by the auto-cruise setting unit, and the vehicle position information detected by the position detector.

### Effects of Invention

According to the present invention, the provision of the controller, which performs control to change the settings made by the auto-cruise setting unit on the basis of the received traffic conditions, the settings in the auto-cruise setting unit, and the vehicle position information detected by the position detector, enhances convenience for drivers who are driving vehicles having an auto-cruise function.

### BRIEF DESCRIPTION OF DRAWINGS

FIG. 1 is a block diagram showing a configuration of an information system according to a first embodiment.

FIG. 2 is a flowchart of processing performed by a vehicle-side system according to the first embodiment.

FIG. 3 illustrates operations of a vehicle-side system according to the first embodiment.

FIG. 4 is a block diagram showing a configuration of a vehicle-side system according to a third embodiment.

FIG. 5 illustrates operations of the vehicle-side system according to the third embodiment.

FIG. 6 illustrates operations of a vehicle-side system according to a fourth embodiment.

FIG. 7 is a block diagram showing a configuration of a vehicle-side system according to a fifth embodiment.

FIG. 8 illustrates operations of a vehicle-side system according to a sixth embodiment.

FIG. 9 illustrates operations of a related probe information system.

FIG. 10 illustrates operations of the related probe information system.

### DESCRIPTION OF EMBODIMENTS

Embodiments of the present invention will be described below with reference to the drawings.

### The First Preferred Embodiment

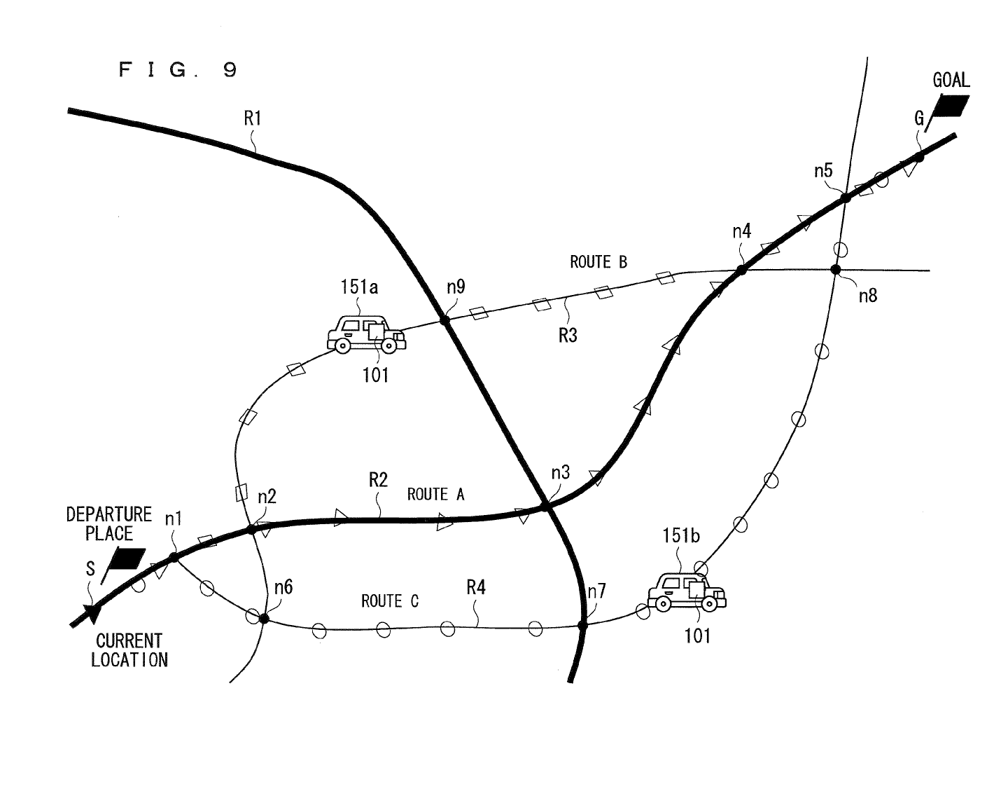

Prior to the description of a vehicle-side system and a center-side system according to a first embodiment of the present invention, a probe information system related to these systems (hereinafter referred to as a “related probe information system”) will be described with reference to FIG. 9.

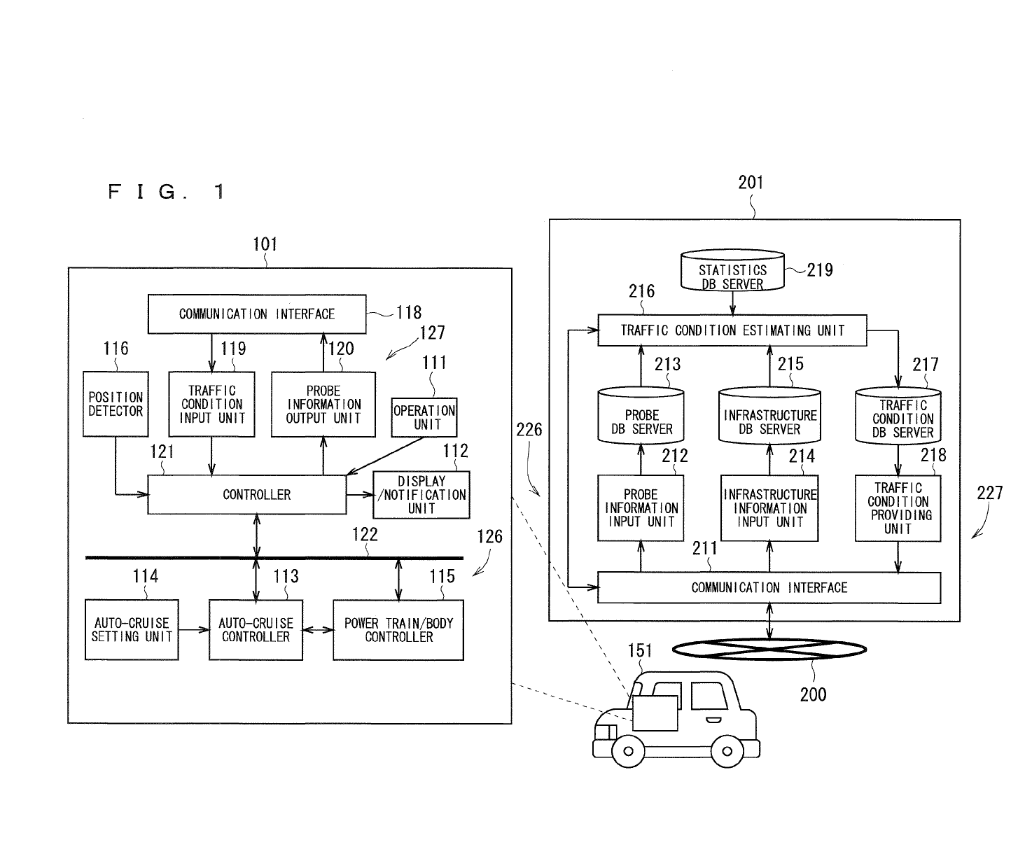

A related probe information system includes a vehicle-side system 101 mounted on each probe vehicle 151 (probe vehicles 151a and 151b) and a center-side system 201 (not shown in FIG. 9, see FIG. 1) such as a traffic condition service system. The vehicle-side system 101 uploads traffic information regarding the road on which the probe vehicle 151 is traveling to the center-side system 201. Upon receiving the uploaded traffic information from the vehicle-side system 101, the center-side system 201 transmits traffic conditions to the outside (each vehicle) on the basis of the traffic information.

In FIG. 9, the probe vehicles 151 are located somewhere between a current location S and a destination G, and there are roads R1 to R4 intersecting at nodes n1 to n9 between the current location S and the destination (location) G.

Among the roads R1 to R4, the roads R1 and R2 indicated by thick lines in FIG. 9 are highways to which Vehicle Information and Communication System (VICS) (registered trademark) information is distributed. It is assumed here that maximum legal speeds (hereinafter referred to as “speed limits”) on these roads are each 60 km/h. The center-side system 201 can acquire, for example, possible traveling speeds and traffic congestion information and the like on the highways such as the roads R1 and R2 by receiving the VICS information. Note that the possible traveling speed refers to a maximum speed at which it is estimated that general vehicles can travel on the target road under the current traffic conditions.

The roads R3 and R4 are not highways to which the VICS information is distributed. It is assumed here that the speed limits on these roads are each 50 km/h. The center-side system 201 cannot acquire the possible traveling speeds on the roads R3 and R4 from the VICS information, but can acquire the possible traveling speeds on the roads R3 and R4 by receiving traffic information uploaded from the vehicle-side system 101 of the probe vehicle 151. To be specific, the center-side system 201 acquires a speed contained in traffic information transmitted by the vehicle-side system 101 of the probe vehicle 151a and sets the acquired speed as the possible traveling speed on the road R3. Likewise, the center-side system 201 acquires a speed contained in traffic information transmitted by the vehicle-side system 101 of the probe vehicle 151b and sets the acquired speed as the possible traveling speed on the road R4.

In FIG. 9, it is assumed here that distance (n1-n2-n3-n4-n5)=distance (n1-n2-n9-n4-n5)=50 km. Note that the distance (n1-n2-n3-n4-n5) refers to the shortest distance of the route passing thoroughly through the nodes n1, n2, n3, n4 and n5, and the distance (n1-n2-n9-n4-n5) refers to the distance of the route sequentially passing through the nodes n1, n2, n9, n4 and n5. Similarly, it is assumed that distance (n1-n2)=distance (n1-n6)=distance (n4-n5)=distance (S-n1)=distance (n5-G)=10 km; distance (n2-n9-n4)=30 km; and distance (n1-n6-n7-n8-n5)=60 km. The possible traveling speed on a road Rn is indicated by Vcn (where n=1 to 4).

Based on the foregoing, hereinafter, a description will be given of common processing used in a vehicle located near the current location (departure place) S to search for a route from the current location S to the destination G when receiving a possible traveling speed Vcn from the center-side system 201.

According to a generally well-known route search logic, the route from the current location S to the destination G is searched for by calculating a link cost (travel cost) of each route from the current location S to the destination G and presenting a route that has the lowest cost as a first candidate (optimal route). In general, the link cost is calculated by the following equation: link cost=(link distance/possible traveling speed)×α (coefficient). In this case, a cost A of a route A shown in FIG. 9 is the total sum of link costs of routes S-n1-n2-n3-n4-n5-G, and is thus (70/Vc2)×α. Likewise, a cost B of a route B is the total sum of link costs of routes S-n1-n2-n9-n4-n5-G, and is thus (40/Vc2+30/Vc3)×α. Likewise, a cost C of a route C is the total sum of link costs of routes S-n1-n6-n7-n8-n5-G, and is thus (20/Vc2+60/Vc4)×α. Hereinafter, it is assumed that α=1 in order to simplify the description.

As can be seen from the above equations, the costs A to C are determined by the possible traveling speeds Vc2 to Vc4 provided from the center-side system 201. While there are various combinations of the possible traveling speeds Vc2 to Vc4, the following describes three cases as examples.

First, a case (case 1) will be described in which none of the roads R1 to R4 are congested. In this case, the possible traveling speeds Vc2, Vc3 and Vc4 are respectively set to the speed limits on the roads R1 to R4, namely, 60 km/h, 50 km/h, and 50 km/h, and the above-described costs A, B and C are respectively (70/60)=35/30, (40/60+30/50)=38/30, and (20/60+60/50)=46/30. In this case, cost A<cost B<cost C, and the route A indicated by a plurality of triangular marks in FIG. 9 is selected as the optimal route.

Next, a case (case 2) will be described in which the center-side system 201 receives VICS information indicating that the possible traveling speed on the road R2 is 40 km/h due to traffic congestion, and the other roads R1, R3 and R4 are not congested. In this case, the possible traveling speed Vc2 is changed, and the possible traveling speeds Vc2, Vc3 and Vc4 are respectively 40 km/h, 50 km/h, and 50 km/h. Accordingly, the above-described costs A, B and C are respectively (70/40)=35/20, (40/40+30/50)=32/20, and (20/40+60/50)=34/20. In this case, cost B<cost C<cost A, and the route B indicated by a plurality of rectangular marks in FIG. 9 is selected as the optimal route.

Next, a case (case 3) will be described in which the center-side system 201 receives the same VICS information as that of case 2 and also receives a speed of 40 km/h from the vehicle-side system 101 of a vehicle traveling on the road R3 and a speed of 50 km/h from the vehicle-side system 101 of a vehicle traveling on the road R4. In this case, the possible traveling speeds Vc2 to Vc4 are changed, and the possible traveling speeds Vc2, Vc3 and Vc4 are respectively 40 km/h, 40 km/h, and 50 km/h. Accordingly, the above-described costs A, B and C are respectively (70/40)=35/20, (40/40+30/40)=35/20, and (20/40+60/50)=34/20. In this case, cost C<cost A=cost B, and the route C indicated by a plurality of circular marks in FIG. 9 is selected as the optimal route.

Next is a description of a case where a vehicle 151 having an auto-cruise function travels while receiving traffic conditions from the center-side system 201. The vehicle does not necessarily have to have a probe function, and can be any vehicle as long as it has an auto-cruise function that allows the vehicle to receive traffic conditions from the center-side system 201. The vehicle is thus simply referred to as a “vehicle 151.”

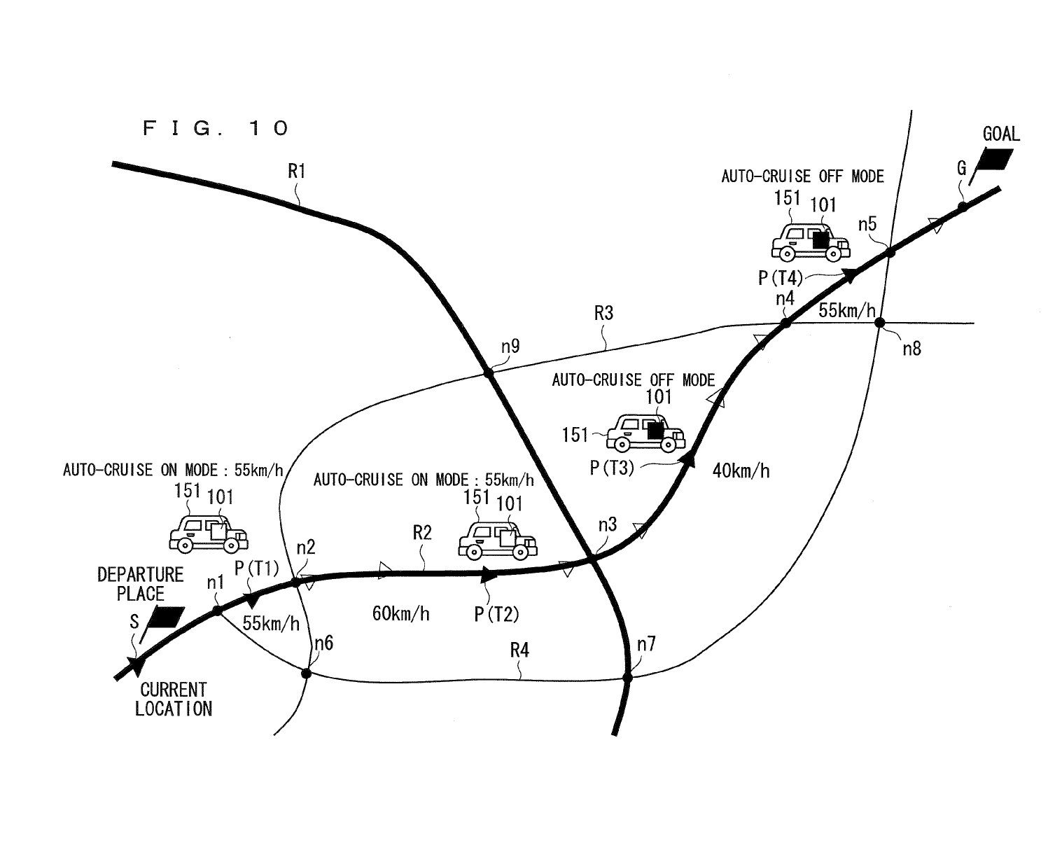

The following description will be given assuming that, as shown in FIG. 10, a vehicle 151 located near the current location (departure place) S travels along the road R2 from the current location S toward the destination G and passes points P(T1), P(T2), P(T3) and P(T4) (indicated by black triangular marks in FIG. 10) at respective times T1, T2, T3, and T4. The traffic conditions transmitted from the center-side system 201 contain information regarding a possible traveling speed in each section between nodes. As the possible traveling speed in each section between nodes, it is assumed here that the possible traveling speed in a section between n1 and n2 is 55 km/h, the possible traveling speed in a section between n2 and n3 is 60 km/h, the possible traveling speed in a section between n3 and n4 is 40 km/h, and the possible traveling speed in a section between n4 and n5 is 55 km/h. It is also assumed that a set speed used in the auto-cruise function (auto-cruise set speed) is set to 55 km/h at a time before time T1, and the vehicle 151 travels in the auto-cruise on mode. Note that, although the possible traveling speed in the section between n3 and n4 is 40 km/h, this section is not so congested, and thus traffic congestion information is not particularly displayed even in a vehicle provided with a car navigation apparatus.

In the sections between n1 and n3, the vehicle 151 travels at the auto-cruise set speed because the auto-cruise set speed is less than or equal to the possible traveling speeds in these sections. However, in the section between n3 and n4, the auto-cruise set speed is higher than the possible traveling speed. If, for example, the vehicle 151 overtakes a preceding vehicle at the point P(T3), the driver presses the brake pedal, and the auto-cruise function is thereby deactivated. In other words, the vehicle 151 travels with the auto-cruise function set to OFF (hereinafter also referred to as “in an auto-cruise off mode”) after the point P(T3).

After that, the vehicle 151 continues to travel in the auto-cruise off mode, even though the auto-cruise set speed is equal to the possible traveling speed in the section between n4 and n5 and thus the vehicle 151 can travel at the auto-cruise set speed. Alternatively, the driver may decide that it is possible to travel in the auto-cruise on mode because there is no preceding vehicle and may activate the auto-cruise function to drive at the auto-cruise set speed.

In this way, with the above-described vehicle 151 having an auto-cruise function, once the auto-cruise function is deactivated by a brake operation or the like, the driver needs to again activate the auto-cruise function even if the vehicle comes into a section where it can travel at the auto-cruise set speed. That is, the driver has to perform the operation of pressing the brake pedal and the operation of activating the auto-cruise function, which are troublesome to the driver.

In view of the above, a vehicle-side system 101 according to the present embodiment automatically changes the auto-cruise set speed in accordance with the traffic conditions received from a center-side system 201. This makes it possible to reduce the number of operations to be performed by a driver, thus eliminating the driver's inconvenience and enhancing convenience for the driver. Hereinafter, the vehicle-side system 101 and the center-side system 201 of the present embodiment will be described.

FIG. 1 is a block diagram showing a configuration of a telematics system including a vehicle-side system 101 and a center-side system 201 of the present embodiment. Note that in FIG. 1, the same reference numerals are given to constituent elements that are similar to those described above. In the present invention, a vehicle 151 may be a probe vehicle that uploads traffic information to the center-side system 201, or may be a non-probe vehicle that does not include a probe information output unit as long as it is capable of receiving traffic conditions from the center-side system 201. The center-side system 201 does not necessarily have to include a probe information input unit as long as it has a function of transmitting possible traveling speeds to the vehicle-side system 101. For the sake of convenience, the description of the present embodiment will be given on the assumption that the vehicle-side system 101 has a function of outputting probe information, and the center-side system 201 has a function of receiving input of the probe information and estimating traffic information.

As shown in FIG. 1, the telematics system includes the vehicle-side system 101 that uploads traffic information regarding the probe vehicle 151 to the center-side system 201, and the center-side system 201 that receives the uploaded traffic information from the vehicle-side system 101, as with the related probe information system described above. The vehicle-side system 101 is mounted on a vehicle 151 having an auto-cruise function and receives traffic conditions from the center-side system 201. Note that the uploading of traffic information and the reception of traffic conditions are implemented via a communication network 200.

The vehicle-side system 101 includes an operation unit 111 configured to receive information operations from the driver, a display/notification unit 112 configured to display/notify various types of information including information regarding the auto-cruise function, an auto-cruise controller 113, an auto-cruise setting unit 114, a power train/body controller 115, a position detector 116, a communication interface 118, a traffic condition input unit 119, a probe information output unit 120, and a controller 121 including a CPU and the like and configured to perform overall control of the constituent elements on the basis of, for example, operations received by the operation unit 111. The controller 121 is connected to the auto-cruise controller 113 and the power train/body controller 115 via an in-vehicle LAN 122. This connection allows the controller 121 to output control signals to the auto-cruise controller 113 and the power train/body controller 115 via the in-vehicle LAN 122 and to receive various types of information from the auto-cruise controller 113 and the power train/body controller 115 via the in-vehicle LAN 122.

Next, the constituent elements of the vehicle-side system 101 will be described.

The power train/body controller 115 includes a power train controller and a body controller that are controlled by the controller 121.

The power train controller includes a group of apparatuses configured to receive input of a driver operation from the brake pedal, the accelerator pedal or the steering wheel (not shown) and control travel of the vehicle 151. For example, the travel controller controls the speed of the vehicle 151 by controlling the engine speed, the brake apparatus, and the like or controls the heading direction of the vehicle 151 by controlling the position of the shaft and the like. The power train controller also acquires a vehicle speed pulse according to the rotational speed of the wheels, and the controller 121 detects the speed of the vehicle 151 on the basis of the vehicle pulse. The body controller includes a group of apparatuses configured to control operations that are not directly related to travel of the vehicle 151 according to a control signal generated by the driver operating an operation input unit (not shown). For example, the body controller controls driving of the wiper, transmission of lighting information, flashing of blinkers, opening and closing of doors, and opening and closing of windows. The power train/body controller 115 is controlled not only by the controller 121 but also by the auto-cruise controller 113.

In the present embodiment, the power train controller and the controller 121 described above constitute a speed detector 126. The speed detector 126 thus configured detects vehicle speed information that is information regarding the speed of the vehicle 151. Note that, in the following description, the vehicle speed information is regarded as the speed of the vehicle 151 itself unless otherwise stated.

The auto-cruise controller 113 controls travel of the vehicle 151, using an auto-cruise function (cruise control function). In the present embodiment, when the auto-cruise setting unit 114 has activated the auto-cruise function and has set a predetermined speed, the auto-cruise controller 113 controls the engine speed and the brake apparatus of the power train/body controller 115 such that the traveling speed of the vehicle 151 is equal to the set auto-cruise set speed (predetermined speed).

There is a type of auto-cruise function called an “advanced auto-cruise function” that includes, in addition to an auto-cruise function, a spacing maintaining function of detecting, for example, a preceding vehicle and automatically maintaining the spacing between its own vehicle and the detected preceding vehicle at a constant distance. In the following, the auto-cruise function refers to an auto-cruise function that does not include the spacing maintaining function unless otherwise stated.

The auto-cruise setting unit 114 makes settings of the above-described auto-cruise function. In the present embodiment, a setting bar (not shown) is provided near the steering wheel as with the generally-used blinker lever. When a predetermined operation is performed on the setting bar, the auto-cruise setting unit 114 activates the auto-cruise function. When a brake operation is performed with the operation unit 111, the auto-cruise setting unit 114 deactivates the auto-cruise function. Also, when a predetermined operation such as rotating the handle of the setting bar is performed, the auto-cruise setting unit 114 changes the set speed or deactivates the auto-cruise function.

Accordingly, in the present embodiment, auto-cruise setting information that is information regarding the settings made by the auto-cruise setting unit 114 includes on and off settings of the auto-cruise function or a setting of the auto-cruise set speed (predetermined speed) at which the auto-cruise function causes the vehicle 151 to travel.

The display/notification unit 112 is configured to visually and/or aurally display and/or notify necessary information. In the present embodiment, it is assumed that the display/notification unit 112 displays and/or notifies information regarding at least the auto-cruise function, and specific display and/or notification operations will be described below in detail.

The position detector 116 includes, for example, a global positioning system (GPS), a yaw rate sensor, and an acceleration sensor and is configured to detect vehicle position information that is information regarding the position of the vehicle 151. It is assumed here that the position detector 116 detects vehicle position information Pk=(xk, yk) as the vehicle position information of the vehicle 151 on an absolute coordinate system of longitude and latitude, for example.

The communication interface 118 communicates with, for example, the center-side system 201 via the communication network 200. The traffic condition input unit 119 provides information received by the communication interface 118 to the controller 121. The probe information output unit 120 provides vehicle-side information of the vehicle 151 to the communication interface 118, and the communication interface 118 transmits the information provided from the probe information output unit 120 to, for example, the center-side system 201.

In the present embodiment, the communication interface 118 and the probe information output unit 120 described above constitute a vehicle-side transmitter 127 serving as a transmitter. The vehicle-side transmitter 127 thus configured transmits information regarding the vehicle 151 such as the vehicle position information detected by the position detector 116, the vehicle speed information detected by the speed detector 126, and the auto-cruise setting information set by the auto-cruise setting unit 114, to the center-side system 201 via the communication network 200. Note that the information regarding the vehicle 151 transmitted by the vehicle-side system 101 may be hereinafter referred to as “vehicle transmission information.” In the present embodiment, the vehicle transmission information is the same as the traffic information uploaded by the vehicle-side system 101.

Next, a configuration of the center-side system 201 will be described.

As shown in FIG. 1, the center-side system 201 includes a communication interface 211, a probe information input unit 212, a probe DB server 213, an infrastructure information input unit 214, an infrastructure DB server 215, a traffic condition estimating unit 216, a traffic condition DB server 217, and a traffic condition providing unit 218. In the present embodiment, the traffic condition estimating unit 216 performs overall control of the center-side system 201.

Next, each constituent element of the center-side system 201 will be described.

The communication interface 211 communicates with, for example, the vehicle-side system 101 of the vehicle 151, and other probe information systems, and VICS centers (none of them are shown) via the communication network 200. In this example, the communication interface 211 receives the vehicle transmission information transmitted from the vehicle-side system 101 via the communication network 200. The vehicle transmission information may be vehicle transmission information received directly from the vehicle 151 or may be vehicle transmission information received indirectly via another probe information system.

The probe information input unit 212 provides the vehicle transmission information received by the communication interface 211 to the probe DB server 213.

The probe DB server 213 stores therein the vehicle transmission information provided from the probe information input unit 212 per road and per time, using road and time as parameters. Needless to say, in the following, the center-side system 201 includes a map database (not shown) so as to be capable of storing various types of information per road.

The infrastructure information input unit 214 provides the VICS information and the infrastructure information received by the communication interface 211 to the infrastructure DB server 215.

The VICS information is information received from a VICS center and includes, for example, possible traveling speeds on highways and traffic congestion information. The infrastructure information is information provided from the VICS center or other probe information systems and includes, for example, the current time and date and weather information per road. The source of various types of information of the infrastructure information may be changed as appropriate. For example, the current date and time may be supplied (measured) by the center-side system 201, and the weather information may be supplied (transmitted) from vehicles.

The infrastructure DB server 215 stores therein the VICS information and the infrastructure information provided from the infrastructure information input unit 214, using, for example, road and time as parameters as with the probe DB server 213.

In the present embodiment, the communication interface 211 and the probe information input unit 212 described above constitute a center-side receiver 226 serving as a receiver. The center-side receiver 226 thus configured receives the vehicle transmission information, or in other words, the information regarding the vehicle 151 from the vehicle-side system 101 of the vehicle 151.

The traffic condition estimating unit 216 analyzes the vehicle transmission information stored in the probe DB server 213 and estimates traffic conditions including possible traveling speeds described above. That is, the traffic condition estimating unit 216 estimates traffic conditions including a possible traveling speed of the vehicle on each road on the basis of the vehicle transmission information received by the center-side receiver 226. Also, in the present embodiment, the traffic condition estimating unit 216 not only estimates a possible traveling speed but also estimates the degree of reliability of the possible traveling speed on the basis of the vehicle transmission information received by the center-side receiver 226 and incorporates the estimated degree of reliability in the traffic conditions. The traffic condition estimating unit 216 also estimates traffic congestion information on the basis of the vehicle transmission information, the infrastructure information and the like and incorporates the estimated traffic congestion information in the traffic conditions. The estimation of the possible traveling speed and the degree of reliability performed by the traffic condition estimating unit 216 will be described later in detail.

The traffic condition DB server 217 stores therein traffic conditions (hereinafter also referred to as “distributed traffic conditions”) per road including, for example, the possible traveling speeds, the degree of reliability, and traffic congestion information determined by the traffic condition estimating unit 216.

The traffic condition providing unit 218 provides the distributed traffic conditions stored in the traffic condition DB server 217 to the communication interface 211, and the communication interface 211 transmits (issues) the distributed traffic conditions to the outside such as the vehicle-side system 101 of the vehicle 151 and other probe information systems.

In the present embodiment, the communication interface 211 and the traffic condition providing unit 218 described above constitute a center-side transmitter 227 serving as a transmitter. The center-side transmitter 227 thus configured transmits the distributed traffic conditions estimated by the traffic condition estimating unit 216 to the outside such as the vehicle-side system 101 of the vehicle 151. In the present embodiment, the distributed traffic conditions are stored per road in the traffic condition DB server 217, and thus the center-side transmitter 227 can transmit the distributed traffic conditions per road.

Next, processing and operations performed by the vehicle-side system 101 will be described.

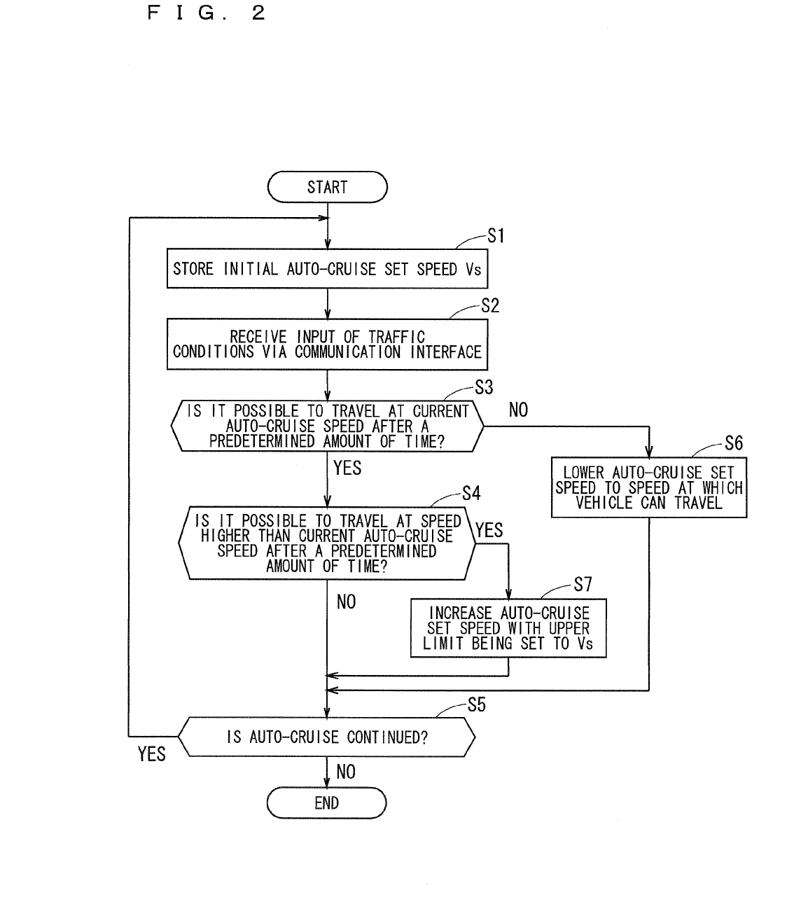

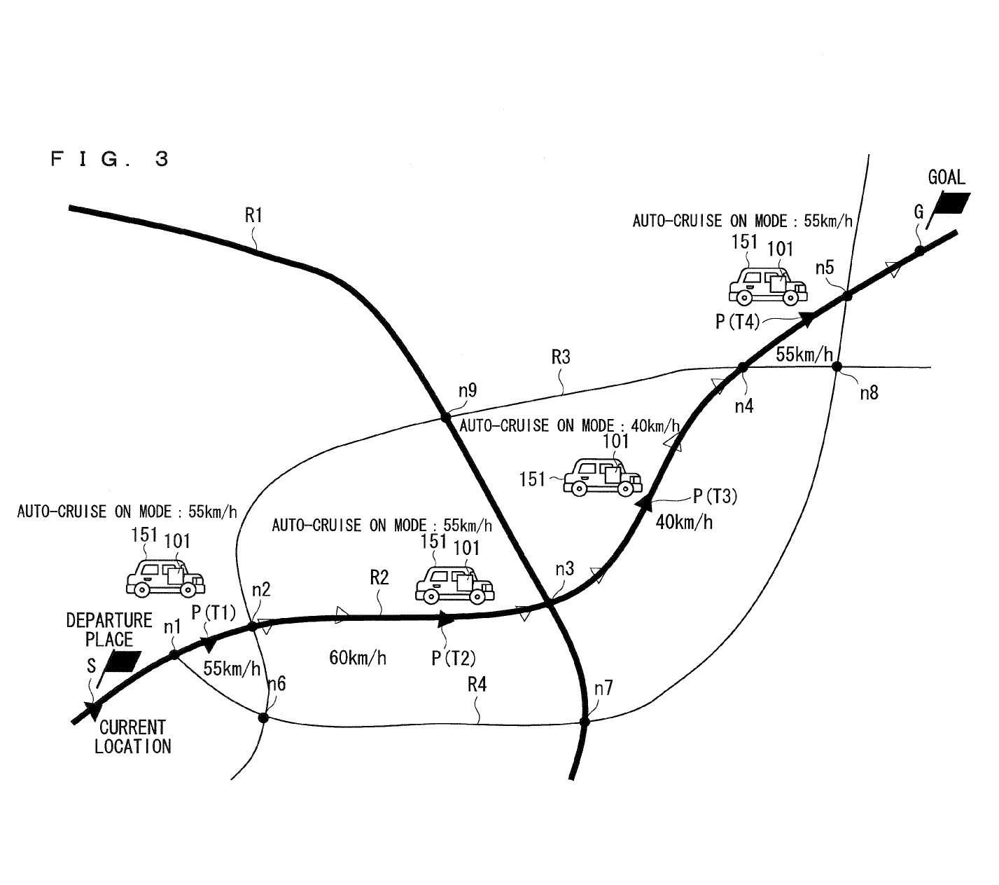

FIG. 2 is a flowchart illustrating processing performed by the vehicle-side system 101 according to the present embodiment. FIG. 3 illustrates operations of the vehicle-side system 101 according to the present embodiment. Note that FIG. 3 is the same as FIG. 10 except for the traveling state of the vehicle 151.

In step S1, the controller 121 causes the auto-cruise setting unit 114 to set the initial value of the auto-cruise set speed as an initial set speed Vs and store the set initial set speed Vs in a predetermined storage unit (not shown). In step S2, the controller 121 acquires the traffic conditions received from the center-side system 201 via the communication interface 118 and the traffic condition input unit 119.

In step S3, the controller 121 determines whether or not it is possible to travel at the current auto-cruise set speed after a predetermined amount of time (e.g., after two minutes), on the basis of the traffic conditions received from the center-side system 201, the auto-cruise set speed (the settings in the auto-cruise setting unit 114) set by the auto-cruise setting unit 114, and the vehicle position information detected by the position detector 116. Although not shown, if the vehicle 151 includes a map database, the vehicle 151 can use the map database to obtain the traffic conditions received from the center-side system 201 and the vehicle position information of the vehicle 151 and determine whether or not the vehicle 151 can travel at the current auto-cruise set speed after a predetermined amount of time. For example, in the case where the vehicle 151 is traveling in the section between n2 and n3 in the auto-cruise on mode and will travel in the section between n3 and n4 two minutes later as shown in FIG. 3, it is determined whether or not the vehicle 151 can travel at the current auto-cruise set speed in the section between n3 and n4 in which the vehicle 151 is supposed to travel two minutes later. That is, the above determination is made two minutes before the vehicle 151 arrives at the node n3.

If the controller 121 determines in step S3 that it is not possible to travel at the current auto-cruise set speed after the predetermined amount of time, then in step S6, the controller 121 changes the auto-cruise set speed to a speed at which the vehicle can travel. For example, in the case where the vehicle 151 is traveling in the section between n2 and n3 in the auto-cruise on mode, the auto-cruise set speed is re-set (changed) to the possible traveling speed in the section between n3 and n4 (here, 40 km/h) a predetermined amount of time (e.g., two minutes) before the vehicle 151 arrives at the node n3.

If the controller 121 determines in step S3 that it is possible to travel at the current auto-cruise set speed after the predetermined amount of time, then in step S4, the controller 121 determines whether or not it is possible to travel at a speed higher than the current auto-cruise set speed after a predetermined amount of time.

If the controller 121 determines in step S4 that it is possible to travel at a speed higher than the current auto-cruise set speed after a predetermined amount of time, then in step S7, the controller 121 re-sets (changes) the auto-cruise set speed with the initial set speed Vs of the auto-cruise speed as the upper limit. For example, in the case where the vehicle 151 is traveling in the section between n3 and n4 in the auto-cruise on mode, the auto-cruise set speed is re-set (changed) to the possible traveling speed in the section between n4 and n5 (here, 55 km/h) a predetermined amount of time (e.g., two minutes) before the vehicle 151 arrives at the node n4. In the case where the possible traveling speed in the section between n4 and n5 is 60 km/h, the auto-cruise set speed is re-set to the initial set speed Vs of the auto-cruise speed (here, 55 km/h). In the case where the possible traveling speed in the section between n4 and n5 is 50 km/h, the auto-cruise set speed is re-set to 50 km/h, which is the possible traveling speed in the section between n4 and n5. In this way, the auto-cruise set speed is re-set with the initial set speed Vs of the auto-cruise speed as the upper limit, but if the possible traveling speed in each section is less than or equal to the current auto-cruise set speed, the auto-cruise set speed is re-set to the possible traveling speed in each section.

If the controller 121 determines in step S4 that it is not possible to travel at a speed higher than the current auto-cruise set speed after a predetermined amount of time, the vehicle 151 travels at the current auto-cruise set speed.

In step S5, the controller 121 determines whether or not the auto-cruise control is continued (or in other words, the driver does not perform an operation of stopping the auto-cruise traveling and the vehicle 151 continues to be traveling in the auto-cruise on mode). If it is determined that the auto-cruise control is continued, the procedure returns to step S1. If it is determined that the auto-cruise control is not continued, the processing shown in FIG. 2 ends.

With the vehicle-side system 101 of the present embodiment described above, the controller 121 changes the settings made by the auto-cruise setting unit 114, on the basis of the traffic conditions received from the center-side system 201, the settings in the auto-cruise setting unit 114, and the vehicle position information detected by the position detector 116. In other words, the vehicle-side system 101 automatically changes the auto-cruise set speed set by the auto-cruise setting unit 114 in accordance with a change in the traffic conditions received from the center-side system 201. This eliminates inconvenience for drivers and enhances convenience for drivers.

While the foregoing has described the processing and operations in which the auto-cruise speed set by the auto-cruise setting unit 114 is changed in accordance with the traffic conditions received from the center-side system 201, such a change in the auto-cruise set speed may be displayed or notified by the display/notification unit 112. This enhances convenience for drivers.

In the present embodiment, if the center-side system 201 recognizes the location where the vehicle 151 is traveling (i.e., the route has already been searched for by either the vehicle-side system 101 or the center-side system 201, and the location of the vehicle 151 traveling on the route is recognized), the vehicle-side system 101 does not necessarily have to include a map database as long as the traffic conditions including possible traveling speed information of the road on which the vehicle 151 is traveling are distributed from the center-side system 201 to the vehicle-side system 101.

When changing the auto-cruise set speed (predetermined speed) set by the auto-cruise setting unit 114, the vehicle-side system 101 can change the auto-cruise set speed to a minimum legal speed or higher. This enhances convenience for drivers.

When the auto-cruise set speed is set to a minimum legal speed or lower, the auto-cruise function may be deactivated, and this fact may be notified to the driver via the display/notification unit 112. If the vehicle 151 has the above-described spacing maintaining function (congestion follow-up function), the vehicle 151 may travel with this function being made effective. It is also possible to provide an interface with which the driver can set in advance which processing is to be performed when the auto-cruise set speed is set to a minimum legal speed or lower. This also enhances convenience for the driver.

While the foregoing has described an example in which the setting of the speed and the determination as to whether or not it is possible to travel at the auto-cruise set speed as in steps 3 and 4 shown in FIG. 2 are performed two minutes before the arrival of the vehicle 151, the amount of time is not limited to two minutes as long as the above-described determination and setting are performed a predetermined amount of time before the arrival of the vehicle 151. The time for which the determination is made may be different between when the auto-cruise set speed is increased and when the auto-cruise set speed is reduced. For example, when the auto-cruise set speed is increased after a predetermined amount of time, the determination may be made three minutes before instead of two minutes before the arrival of the vehicle 151. This is because generally, drivers feel an increased psychological burden when the speed increases, and this gives the driver more time.

While the foregoing describes a case in which the setting of the speed and the determination as to whether or not it is possible to travel at the auto-cruise set speed are performed a predetermined amount of time before the arrival of the vehicle 151, the determination may be made at a predetermined distance before the arrival of the vehicle 151. It is also possible to make the determination by combining the speed information of the vehicle 151 and distance information. With this configuration, the same effects as above can be obtained.

While the foregoing describes a case in which the determination as to whether or not it is possible to travel at the auto-cruise set speed is made a predetermined amount of time before the arrival of the vehicle 151, and if it is possible to travel at the auto-cruise set speed, the auto-cruise speed is changed at that time, the auto-cruise set speed may be gradually changed to a re-set speed over a predetermined amount of time. With this configuration, the auto-cruise set speed can be changed without giving the driver a discomfort.

When the auto-cruise set speed has been changed in step S3 or 4 shown in FIG. 2, the vehicle-side system 101 may notify the driver this fact via the display/notification unit 112. When the vehicle 151 is traveling at a speed lower than the initial set speed Vs of the auto-cruise speed, this fact may be notified to the driver via the display/notification unit 112. This also enhances convenience for the driver.

The vehicle-side system 101 may set the auto-cruise set speed set by the auto-cruise setting unit 114 to a maximum value of the speed limit. In this case, the initial set speed Vs of the auto-cruise speed is not set in step S1 in FIG. 2. When the vehicle-side system 151 does not include map information, it may receive information regarding speed limits from the center-side system 201. Alternatively, road signs may be read through, for example, image processing (not shown). This enables the driver to omit the operation of setting the initial set speed Vs of the auto-cruise speed.

A configuration is also possible in which the vehicle-side system 101 receives preceding vehicle information that is information regarding preceding vehicles and is contained in the traffic conditions transmitted from the center-side system 201, and on the basis of the received preceding vehicle information, provides a notification to the driver via the display/notification unit 112 and changes the auto-cruise set speed. This configuration makes it possible to accurately grasp and control the timing at which the auto-cruise set speed is reduced, thus enhancing convenience for the driver.

When the vehicle 151 is a probe vehicle, the vehicle-side system 101 may transmit the vehicle position information detected by the position detector 116 to the center-side system 201 and receive only necessary information regarding the surroundings of the vehicle 151 from the center-side system 201. Alternatively, the vehicle-side system 101 may transmit the vehicle speed information detected by the speed detector 126 to the center-side system 201. Alternatively, the vehicle-side system 101 may transmit the information set by the auto-cruise setting unit 114 as auto-cruise setting information from the vehicle-side transmitter 127 to the center-side system 201. With this configuration, it is possible to receive more accurate traffic conditions from the center-side system 201.

### <The Second Preferred Embodiment>

A feature of a second embodiment of the present invention is that the vehicle-side system 101 receives the degree of reliability of traffic conditions included in the traffic conditions transmitted from the center-side system 201 and changes the auto-cruise set speed on the basis of also the received degree of reliability of the traffic conditions. The other constituent elements and operations are similar to those of the first embodiment, and thus descriptions thereof are omitted here.

Hereinafter, operations performed by a vehicle-side system 101 according to the second embodiment will be described with reference to FIG. 3.

The vehicle-side system 101 receives traffic conditions containing a possible traveling speed in each section and the degree of reliability of the possible traveling speed from the center-side system 201 via the communication interface 118 and the traffic condition input unit 119. As the possible traveling speed in each section, it is assumed here that the possible traveling speed in the section between n1 and n2 is 55 km/h, the possible traveling speed in the section between n2 and n3 is 60 km/h, the possible traveling speed in the section between n3 and n4 is 40 km/h, and the possible traveling speed in the section between n4 and n5 is 55 km/h. As the degree of reliability of the possible traveling speed in each section, it is assumed that the degree of reliability in the section between n1 and n2 is “5”, the degree of reliability in the section between n2 and n3 is “3”, the degree of reliability in the section between n3 and n4 is “3”, and the degree of reliability in the section between n4 and n5 is “1”.

The controller 121 of the vehicle-side system 101 changes the auto-cruise set speed set by the auto-cruise setting unit 114 on the basis of the received traffic conditions and the degree of reliability, the auto-cruise set speed set by the auto-cruise setting unit 114, and the vehicle position detection information detected by the position detector 116. At this time, the controller 121 changes the auto-cruise set speed according to the reliability, and specifically, sets the auto-cruise set speed in a section having a low degree of reliability to the safer side (a lower speed).

For example, in the first embodiment, when the vehicle 151 is traveling in the section between n2 and n3 in the auto-cruise on mode, the auto-cruise set speed is set to 40 km/h, which is the possible traveling speed in the section between n3 and n4, a predetermined amount of time (e.g., two minutes) before the vehicle 151 arrives at the node n3. In the present embodiment, because it is found from the received degrees of reliability that the degree of reliability in the section between n3 and n4 is “3,” the possible traveling speed in this section is reduced by 5% and the resultant value, namely, 40−40×0.05=35 km/h, is re-set as the auto-cruise set speed. As to the section between n4 and n5, since the degree of reliability is “1,” the possible traveling speed in this section is reduced by 10% and the resultant value, namely, 55−55×0.1=49.5 km/h, is re-set as the auto-cruise set speed.

According to the present embodiment described above, the vehicle-side system 101 receives the degrees of reliability of the traffic conditions included in the traffic conditions transmitted from the center-side system 201 and re-sets (changes) the auto-cruise set speed on the basis of also the received degrees of reliability of the traffic conditions. This allows the auto-cruise set speed to be changed on the basis of more accurate information, thus eliminating inconvenience for the driver and enhancing convenience for the driver.

In the foregoing description, the auto-cruise set speed is changed on the basis of the degree of reliability, but it is also possible to, instead of changing the auto-cruise set speed, change in advance the time at which determination is made as to whether or not it is possible to travel at the auto-cruise set speed (how many minutes before the determination is made). For example, the determination may be made two minutes before when the degree of reliability is “5,” three minutes before when the degree of reliability is “3,” or four minutes before when the degree of reliability is “1.”

### <The Third Preferred Embodiment>

A feature of a third embodiment is that sections in which the traveling vehicle 151 can travel at the currently set auto-cruise set speed are displayed on the map in the display/notification unit 112. A vehicle-side system 101 according to the present embodiment has a navigation function of using information in an in-vehicle map DB 117 to search for a traveling route to a destination and guide the user on the vehicle to the destination along the traveling route.

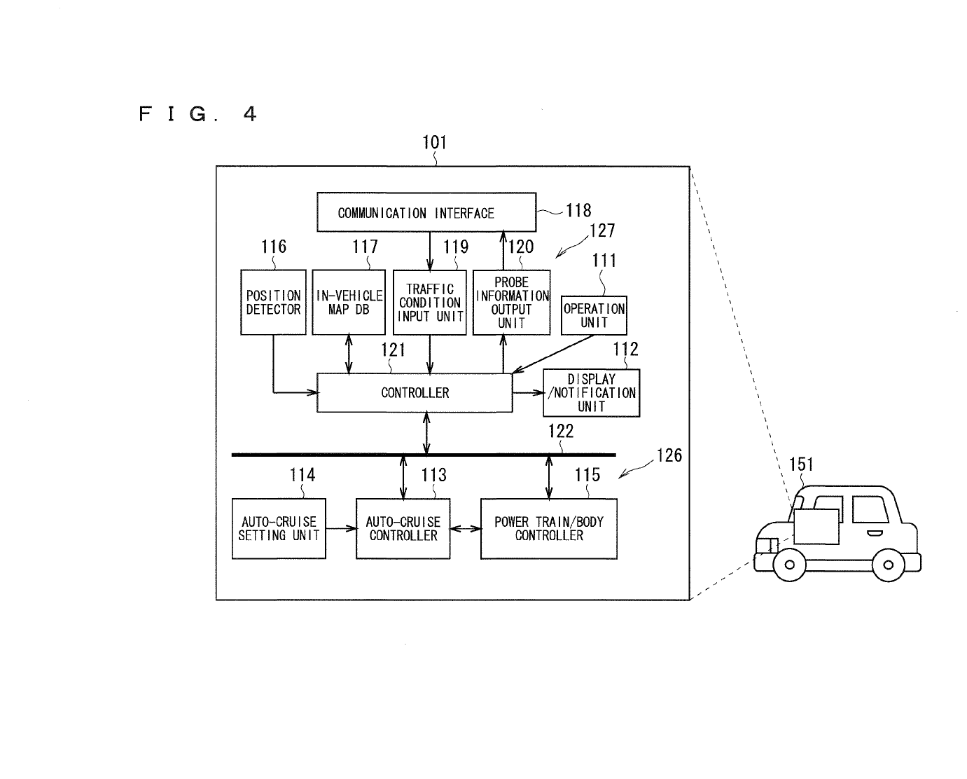

FIG. 4 is a block diagram showing a configuration of a vehicle-side system 101 according to the third embodiment. As shown in FIG. 4, the vehicle system 101 according to the third embodiment of the present invention further includes, in addition to the constituent elements of the vehicle-side system 101 according to the first embodiment, the in-vehicle map DB 117 (map database) in which map information including road information is stored. The other constituent elements and operations including the center-side system 201 are similar to those of the first embodiment, and thus descriptions thereof are omitted here.

The in-vehicle map DB 117 stores map information including map data to which absolute coordinates and link numbers are added, and information regarding facilities that can be set as destinations (e.g., information such as the official names and common names of facilities and the coordinate positions of facilities on the map).

The controller 121 has a car navigation function and controls the constituent elements so as to display a map, detect the position of the vehicle, search for a route, guide a route, and display traffic congestion information.

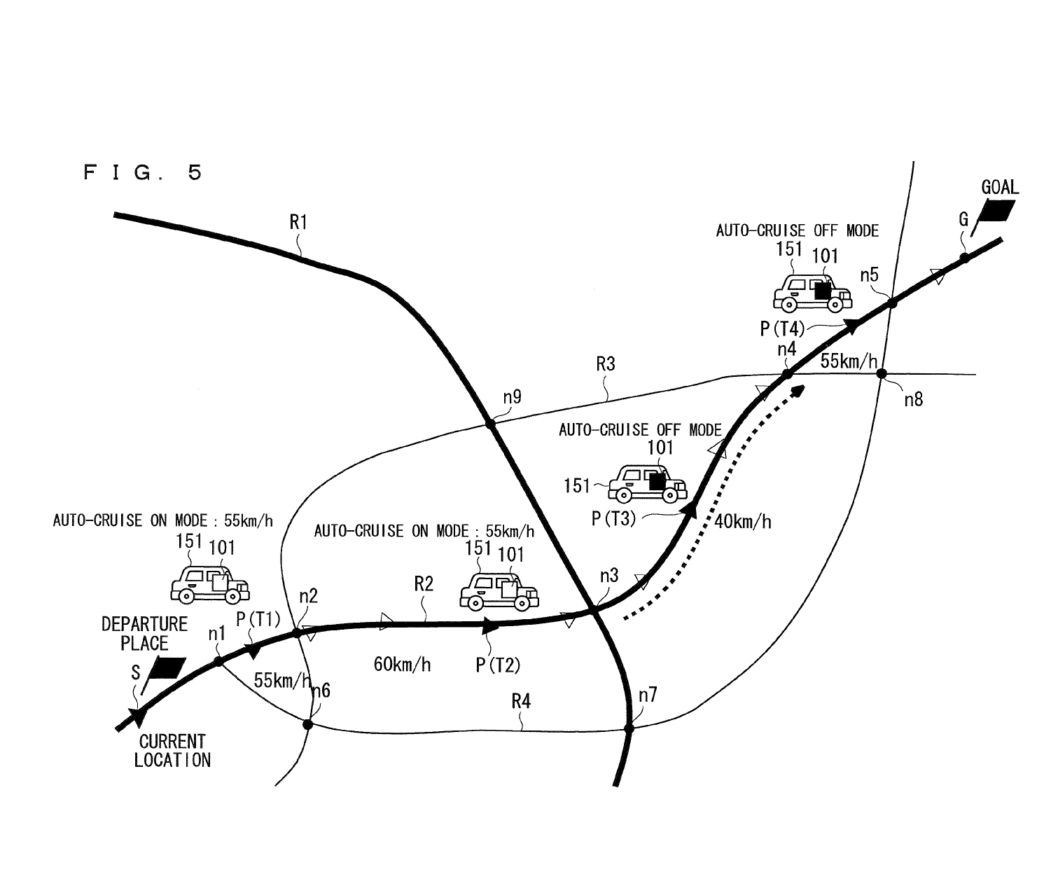

FIG. 5 illustrates operations of the vehicle-side system 101. The display/notification unit 112 displays information as shown in FIG. 5 the map. Specifically, the controller 121 has a route search function of searching for a route along which the vehicle 151 is to travel, and the display/notification unit 112 incorporates information regarding the route searched by the route search function into the map information and displays them together.

The vehicle-side system 101 receives traffic conditions including a possible traveling speed in each section from the center-side system 201 via the communication interface 118 and the traffic condition input unit 119 (receiver). As the possible traveling speed in each section, it is assumed here that the possible traveling speed in a section between n1 and n2 is 55 km/h, the possible traveling speed in a section between n2 and n3 is 60 km/h, the possible traveling speed in a section between n3 and n4 is 40 km/h, and the possible traveling speed in a section between n4 and n5 is 55 km/h. It is also assumed that the vehicle 151 located near the current location (departure place) S is traveling in the auto-cruise on mode at the auto-cruise set speed of 55 km/h.

On the basis of the above assumption, as shown in FIG. 5, it is not possible to travel at the auto-cruise set speed in the section between n3 and n4 and the section between n4 and n5, and thus the controller 121 controls the display/notification unit 112 to display information indicating that the vehicle 151 will travel in the auto-cruise off mode in the section between n3 and n4 and the section between n4 and n5. For example, in order to indicate that the vehicle 151 cannot travel at the auto-cruise set speed in the next section, namely, the section between n3 and n4, the controller 121 controls the display/notification unit 112 to show a dashed arrow along that road. In this way, the controller 121 determines whether or not the vehicle 151 can subsequently travel at the auto-cruise set speed set by the auto-cruise setting unit 114 on the basis of the traffic conditions received from the center-side system 201, and controls the display/notification unit 112 to display the determined result.

With the vehicle-side system 101 of the present embodiment, sections in which the travelling vehicle 151 can travel at the currently set auto-cruise set speed are displayed on the map by the display/notification unit 112. This enhances the driver's convenience.

When the possible traveling speed in a section is within a predetermined range of a change in speed from the auto-cruise set speed, the display/notification unit 112 may, for example, change the form of indication on display by means of, for example, reducing the thickness of the above dashed line if the possible traveling speed in a given section is 55 km/h.

The display/notification unit 112 may display roads possible traveling at the auto-cruise set speed with blue and roads not possible traveling at the auto-cruise set speed with red, or may display roads possible traveling at the auto-cruise set speed with blue arrows and roads not possible traveling at the auto-cruise set speed with red arrows.

At this time, the blue arrows may be displayed above the roads, and the red arrows may be displayed below the roads. In this way, the display/notification unit 112 distinguishes roads possible traveling at the auto-cruise set speed and road not possible traveling at the auto-cruise set speed when displaying roads as a result of the determination made by the controller 121 as to whether or not it is possible to travel at the auto-cruise set speed. This enhances the driver's convenience.

A configuration is also possible in which when the vehicle 151 approaches the node n3 from which it is not possible to travel at the set speed of the auto-cruise function (e.g., when the vehicle 151 approaches one kilometer before the node n3 or five minutes before the arrival at the node n3), the display/notification unit 112 provides a notification indicating that “traveling at the set speed of the auto-cruise function will shortly become unavailable.” At this time, a red arrow may be flashed.

When the auto-cruise function has been deactivated at the node n3 and the vehicle 151 approaches the node n4 from which it is possible to travel at the set speed of the auto-cruise function, the display/notification unit 312 provides a notification indicating that “traveling at the set speed of the auto-cruise function will shortly become available.” At this time, a blue arrow may be flashed. In other words, if the auto-cruise set speed set by the auto-cruise setting unit 114 has been canceled and thereafter the controller 121 determines on the basis of the received traffic conditions that it is possible to travel at the auto-cruise set speed that was set and canceled by the auto-cruise setting unit 114, the display/notification unit 112 may display/notify that determined result.

The method of display in the display/notification unit 112 or the setting of alarms may be changed in response to a predetermined operation from the user via the operation unit 111.

When there is a section in which it is not possible to travel at the auto-cruise set speed, the display/notification unit 112 may display/notify that fact a predetermined amount of time or a predetermined distance before the vehicle arrives the section.

When the controller 121 determines, on the basis of the map information stored in the in-vehicle map DB 117 and the traffic conditions received form the center-side system 201, that the vehicle 151 is currently traveling on a road with poor visibility and that it is not possible to travel at the auto-cruise set speed set by the auto-cruise setting unit 114 after traveling on the road with poor visibility, the display/notification unit 112 may display/notify that fact earlier than usual. At this time, the auto-cruise set speed may be changed (re-set) earlier than usual.

### <The Fourth Preferred Embodiment>

The third embodiment describes a case in which sections in which the traveling vehicle 151 can travel at the currently set auto-cruise set speed are displayed on a map by the display/notification unit 112. A feature of a fourth embodiment according to the present invention is that the auto-cruise set speed is re-set (changed) on the basis of the traffic conditions received from the center-side system 201 and that the display/notification unit 112 displays the auto-cruise set speed in each section on a map. In other words, a vehicle-side system 101 according to the present embodiment performs a combination of the processing and operations of the first and third embodiments. The constituent elements and operations of the vehicle-side system 101 are similar to those of the third embodiment, and thus descriptions thereof are omitted here.

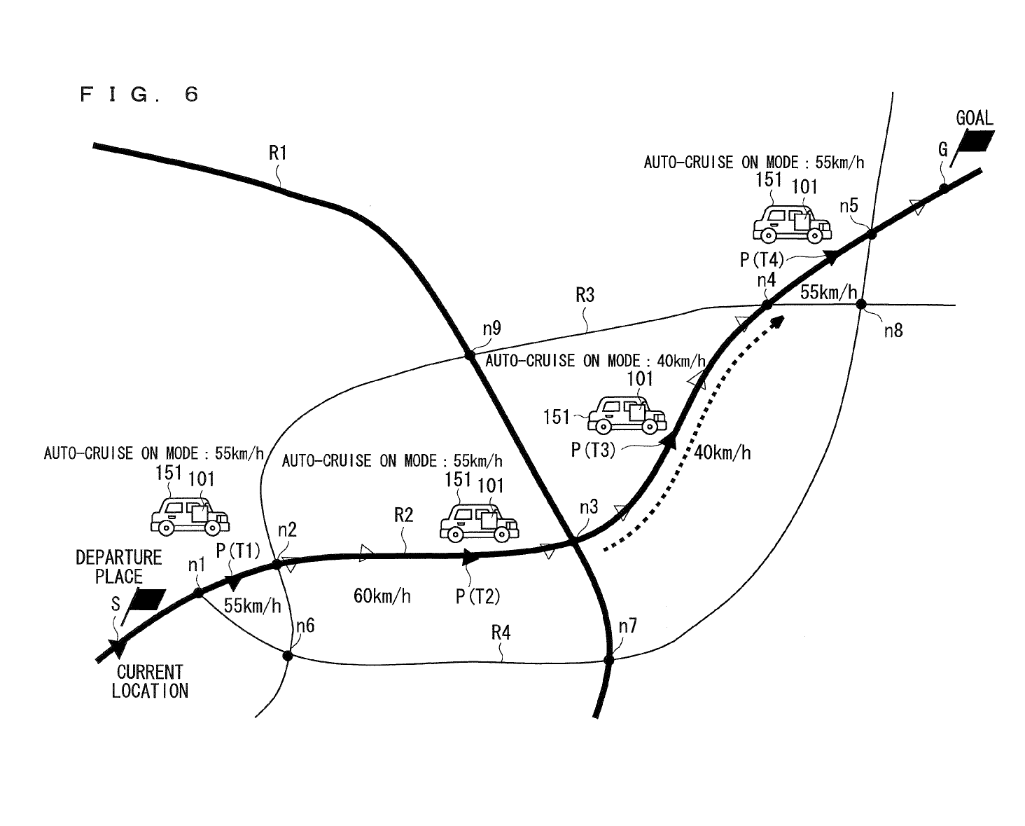

FIG. 6 illustrates operations performed by the vehicle-side system 101. The display/notification unit 112 displays information as shown in FIG. 6 on a map. The difference of FIG. 6 from the display of the third embodiment shown in FIG. 5 is that information regarding the auto-cruise set speed is displayed in the section between n3 and n4 and in the section between n4 and n5. As described in the first embodiment (see FIG. 3), in the vehicle-side system 101 of the present embodiment, the auto-cruise set speed of the vehicle 151 that is traveling at 55 km/h in the section between n2 and n3 is changed to 40 km/h in the section between n3 and n4 and then to 55 km/h in the section between n4 and n5. Then, the display/notification unit 112 displays the auto-cruise set speed in each section.

The vehicle-side system 101 of the present embodiment changes the auto-cruise set speed according to the traffic conditions received from the center-side system 201 and displays the auto-cruise set speed in each section. This further enhances the driver's convenience as compared to the third embodiment.

### <The Fifth Preferred Embodiment>

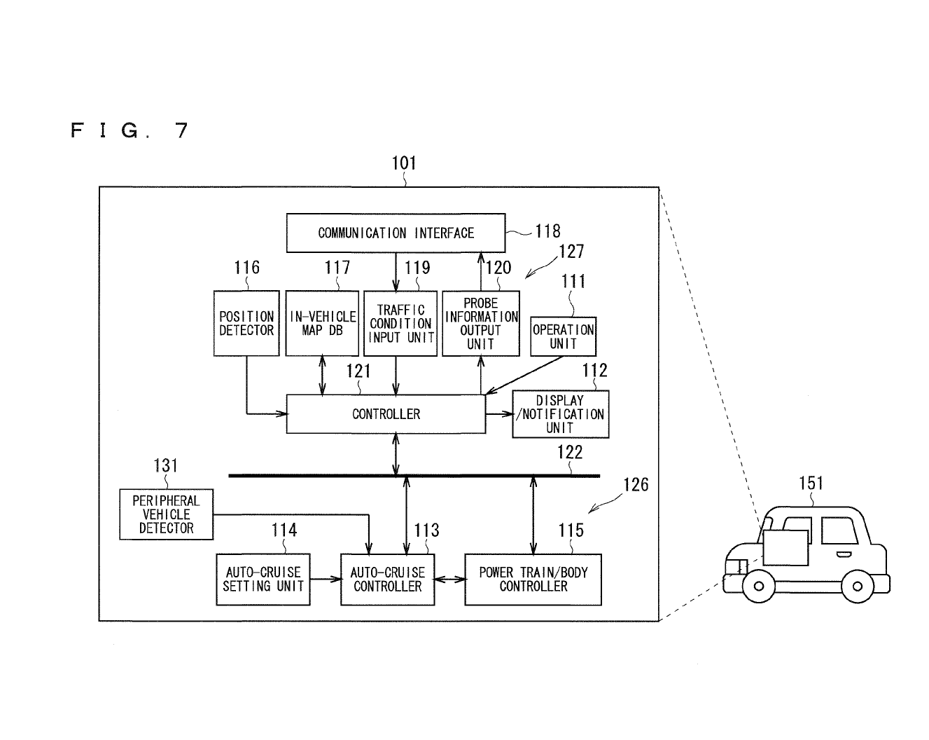

FIG. 7 is a block diagram showing a configuration of a vehicle-side system 101 according to the fifth embodiment of the present invention. A feature of a fifth embodiment is that a vehicle 151 of the fifth embodiment is a probe vehicle and includes a peripheral vehicle detector 131 (peripheral mobile object detector) configured to detect peripheral mobile object detection information that is information regarding the presence or absence of a mobile object (vehicle) around the vehicle 151, and the peripheral mobile object detection information detected by the peripheral vehicle detector 131 is transmitted to the center-side system 201 via the probe information output unit 120 and the communication interface 118.

As shown in FIG. 7, the vehicle-side system 101 is configured by adding the peripheral vehicle detector 131 serving as a peripheral mobile object detector to the vehicle-side system 101 of the third embodiment and implements the aforementioned advanced auto-cruise function. To be specific, the peripheral vehicle detector 131 detects peripheral vehicle detection information (peripheral mobile object detection information) that is information regarding the presence or absence of a preceding vehicle (mobile object) around the vehicle 151. In the present embodiment, the peripheral vehicle detector 131 is configured by, for example, a known laser radar, a millimeter wave radar, an image processing sensor, or an ultrasonic sensor and measures an intervehicular distance between the vehicle 151 and a preceding vehicle in the range of a given distance (e.g., 120 m) or less.

When having determined on the basis of the intervehicular distance detected by the peripheral vehicle detector 131 that the vehicle 151 may collide with the preceding vehicle, the auto-cruise controller 113 performs control so as to appropriately (gradually) reduce the speed of the vehicle 151 to a speed less than or equal to the set speed of the auto-cruise function so that the vehicle 151 travels following the preceding vehicle.

In this way, in the present embodiment, the aforementioned advanced auto-cruise function is implemented in the vehicle 151 as a result of the peripheral vehicle detector 131 and the auto-cruise controller 113 operating in collaboration.

With the vehicle-side system 101 of the present embodiment described above, when it is determined that the vehicle 151 may collide with a preceding vehicle, the speed of the vehicle 151 is gradually reduced to a speed less than or equal the set speed of the auto-cruise function so that the vehicle 151 travels following the perceiving vehicle. Accordingly, the vehicle 151 can travel without giving the driver a discomfort.

By transmitting the peripheral vehicle detection information detected by the peripheral vehicle detector 131 to the center-side system 201, it is possible to improve the accuracy of the possible traveling speed in each section estimated by the center-side system 201.

### <The Sixth Preferred Embodiment>

A feature of a sixth embodiment of the present invention is that a vehicle-side system 101 according to the sixth embodiment has a route search function of searching for a route along which the vehicle 151 is to travel, and if it is determined that the vehicle 151 cannot travel the searched route at the auto-cruise set speed (predetermined speed) set by the auto-cruise setting unit 114, another route where a change in the auto-cruise set speed is within a predetermined range is again searched for as the searched route, and the result of the search is displayed in the display/notification unit 115. The configuration of the vehicle-side system 101 of the present embodiment is similar to that of the vehicle-side system 101 of the fourth embodiment, and thus descriptions thereof are omitted here.

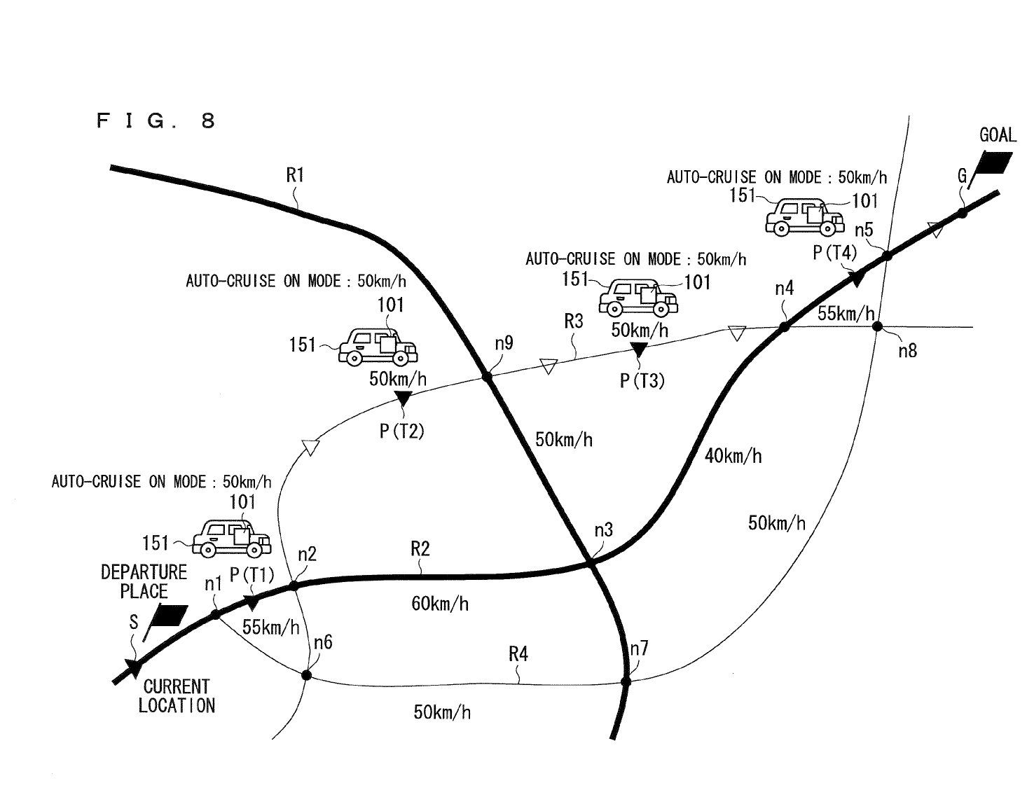

FIG. 8 illustrates operations performed by the vehicle-side system 101 of the present embodiment. The diagram shown in FIG. 8 may be displayed in the display/notification unit 112. It is assumed that the vehicle 151 is in the auto-cruise on mode, and the auto-cruise set speed is set to 50 km/h. It is also assumed that information regarding possible traveling speeds is distributed to each section of roads from the center-side system 201.

As shown in FIG. 8, when the vehicle 151 travels along a route (n2-n3-n4), the auto-cruise set speed is set to a lower speed in the section between n3 and n4. When traveling along a route (n2-n9-n4), the vehicle 151 can travel at the auto-cruise set speed in all sections without changing the auto-cruise set speed. The vehicle-side system 101 of the present embodiment searches for, as a preference auto-cruise route, a route on which the vehicle 151 can travel at the auto-cruise set speed without changing the auto-cruise set speed as little as possible.

With the above-described vehicle-side system 101 of the present embodiment, if it is determined that the vehicle 151 cannot travel the searched route at the auto-cruise set speed set by the auto-cruise setting unit 114, another route where the change in the auto-cruise set speed is within a predetermined range is again searched for as a searched route. This allows the vehicle 151 to travel at the desired auto-cruise set speed set by the driver, thus reducing the stress of the driver as well as enhancing the driver's convenience. Since the vehicle 151 travels with a minimum change in the vehicle speed, the present invention is also useful from an ecological viewpoint.

The aforementioned preference auto-cruise route is searched for by calculating a link cost through weighting the amount of change in the auto-cruise set speed and using the calculated link cost as a basis. For example, when the amount of change in the auto-cruise set speed is 10 km/h, the link cost calculated without weighting is multiplied by 1.2 times, and when the amount of change in the auto-cruise set speed is 5 km/h, the link cost calculated without weighting is multiplied by 1.1 times.

In the vehicle-side system 101 of the third embodiment, traffic conditions of only searched routes are displayed, but in the vehicle-side system 101 of the present embodiment, the possible traveling speed in each section of all the roads may be displayed on the basis of the traffic conditions.

While, in the embodiment given above, the auto-cruise set speed is calculated by the vehicle-side system 101, control may be performed such that processing similar to that of FIG. 2 is performed by the center-side system 201 and the auto-cruise set speed is transmitted so that the vehicle-side system 101 causes the vehicle to travel at the received auto-cruise set speed.

While, in the first embodiment, the operation unit 111 and the display/notification unit 112 are provided to display a map or to provide a notification, only auto-cruise control may be performed without performing such display or notification. In this case, an inexpensive system can be provided by omitting the operation unit 111 and the display/notification unit 112.

Routes are made available via a communication unit 101 or a portable information terminal by the driver accessing a route search server (not shown) from a portable information terminal (not shown) and setting a destination in advance. In this case, the center-side system 201 may also function as a route search server.

The first embodiment has been described assuming that the traveling route has already been set in the vehicle 151, but in the case where the traveling route has not been set, the traveling route may be estimated on the basis of learned data regarding past traveling routes, and the auto-cruise set speed may be determined on the basis of the possible traveling speed information. Alternatively, branch roads on which the set speed needs to be reduced may be indicated by dashed lines as in FIG. 5. Also, a different method may be used to display branch roads on which speeds are changed significantly.

It is also possible to determine possible traveling speeds on all roads or only major branch roads at forks of highways, and the lowest possible traveling speed may be set as the auto-cruise set speed. Alternatively, the auto-cruise set speed may be set by giving a highest priority to a route that goes straight, and if it is necessary to change the auto-cruise set speed when the vehicle has turned right or left, such changes may be notified in the form of audio or display.

A configuration is also possible in which the auto-cruise set speed is set by giving a highest priority to a route that goes straight and is then set according to the traveling road upon detection of a blinker signal indicating a right or left turn or upon detecting that the vehicle has entered a right-turn or left-turn lane. In general, when the vehicle turns right or left, the speed needs to be reduced and accordingly the driver temporarily has to drive the vehicle manually. In such a case, the auto-cruise mode may be automatically set on the basis of the possible traveling speed information after the vehicle has turned right or left. Processing performed in the vehicle-side system 101 may involve setting how much automatic processing is to be performed, such as whether or not to automatically set the auto-cruise mode, and processing for setting the content of display/notification. In this case, auto-cruise control and display/notification intended by the driver are possible.

While, in the above embodiments, the vehicle-side systems receive traffic conditions from the center-side system located outside vehicles, the traffic conditions may be received not only from the center-side system but also from VICS traffic information provided by FM multiplex broadcasting, on-street equipment located outside the vehicle such as a radio beacon or an optical beacon, or a road-to-vehicle communication infrastructure located outside the vehicle to provide DSRC and other traffic conditions. The traffic conditions may also be input via vehicle-to-vehicle communication or other communication units. A configuration is also possible in which traffic condition information received from the center-side system located outside vehicles is temporarily received by a mobile phone and is then input from the mobile phone via short-range communication such as Bluetooth (registered trademark) or a wireless LAN.

It should be noted that the present invention can be implemented by freely combining the above embodiments or by making a modification or omission on the embodiments as appropriate without departing from the scope of the present invention.

### Description of Reference Numerals

101 vehicle-side system
111 operation unit
112 display/notification unit
113 auto-cruise controller
114 auto-cruise setting unit
115 power train/body controller
116 position detector
117 in-vehicle map DB
118 communication interface
119 traffic condition input unit
120 probe information output unit
121 controller
122 in-vehicle LAN
126 speed detector
127 vehicle-side transmitter
131 peripheral vehicle detector
151 vehicle
200 communication Network
201 center-side system
211 communication interface
212 probe information input unit
213 probe DB server
214 infrastructure information input unit
215 infrastructure DB server
216 traffic condition estimating unit
217 traffic condition DB server
218 traffic condition providing unit
219 statistics DB server
226 center-side receiver
227 center-side transmitter

1. A vehicle-side system that is mounted on a vehicle having an auto-cruise function and is capable of receiving traffic conditions from outside said vehicle, said vehicle-side system comprising:
a position detector that detects vehicle position information that is information regarding a position of said vehicle;
a receiver that receives said traffic conditions;
an auto-cruise setting unit that makes settings including a setting of a predetermined speed at which said auto-cruise function causes said vehicle to travel, and
a controller that performs control to change said settings made by said auto-cruise setting unit on the basis of said traffic conditions received by said receiver, said settings made by said auto-cruise setting unit, and said vehicle position information detected by said position detector.

2. The vehicle-side system according to claim 1, further comprising
a display/notification unit that provides display/notification,
wherein said controller performs control on said display/notification unit to provide display/notification regarding said auto-cruise function or performs control to change said settings made by said auto-cruise setting unit, on the basis of said traffic conditions received by said receiver, said settings made by said auto-cruise setting unit, and said vehicle position information detected by said position detector.

3. The vehicle-side system according to claim 1, wherein
said receiver receives a degree of reliability of said traffic conditions, said degree of reliability being contained in said traffic conditions, and
said controller performs said control on the basis of said degree of reliability of said traffic conditions received by said receiver.

4. The vehicle-side system according to claim 2, further comprising
a map database storing map information including road information,
wherein said display/notification unit displays said map information on the basis of said control performed by said controller.

5. The vehicle-side system according to claim 2, wherein
said controller determines, on the basis of said traffic conditions received by said receiver, whether or not said vehicle is capable of subsequently traveling at said predetermined speed set by said auto-cruise setting unit, and
said display/notification unit displays/notifies a result of said determination performed by said controller.

6. The vehicle-side system according to claim 5, wherein
said display/notification unit distinguishes a road possible traveling at said predetermined speed and a road not possible traveling at said predetermined speed when displaying roads as said result of said determination performed by said controller.

7. The vehicle-side system according to claim 2, wherein
when, after said settings made by said auto-cruise setting unit are canceled, said controller determines on the basis of said traffic conditions received by said receiver that it is possible to travel at said predetermined speed that has been set and canceled by said auto-cruise setting unit,
said display/notification unit displays/notifies a result of said determination performed by said controller.

8. The vehicle-side system according to claim 1, wherein
said controller changes said predetermined speed set by said auto-cruise setting unit to a minimum legal speed or higher when changing said predetermined speed.

9. The vehicle-side system according to claim 1, wherein
said controller determines, according to said traffic conditions received by said receiver, said predetermined speed set by said auto-cruise setting unit at a time or position that is determined according to a predetermined rule and is a time or position prior to a time or position at which said predetermined speed is to be changed, and gradually change a current set speed to said predetermined set speed.

10. The vehicle-side system according to claim 4, wherein
said controller has a route search function of searching for a route on which said vehicle is to travel, and
said display/notification unit incorporates information regarding said route searched by said route search function into said map information and displays said map information under said control of said controller.

11. The vehicle-side system according to claim 10, wherein
said controller, when it is determined that said vehicle cannot travel said searched route at said predetermined speed set by said auto-cruise setting unit, search for another route where a change in said predetermined speed is within a predetermined range as said searched route and control said display/notification unit on the basis of a result of said search.

12. The vehicle-side system according to claim 2, wherein
said receiver receives preceding vehicle information that is information regarding a preceding vehicle and is contained in said traffic conditions, and
said controller controls said display/notification unit and said auto-cruise setting unit on the basis of said preceding vehicle information.

13. The vehicle-side system according to claim 4, wherein
said controller controls said display/notification unit and said auto-cruise setting unit earlier than usual when it is determined, on the basis of said map information stored in said map database and said traffic conditions received by said receiver, that said vehicle is currently traveling on a road with poor visibility and that it is not possible for said vehicle to travel at said predetermined speed set by said auto-cruise setting unit after traveling on said road with poor visibility.

14. The vehicle-side system according to claim 1, wherein
when said vehicle is a probe vehicle, said probe vehicle further includes a transmitter that transmits information regarding said settings made by said auto-cruise setting unit to outside said vehicle as auto-cruise setting information.

15. The vehicle-side system according to claim 14, wherein
said probe vehicle further includes a peripheral mobile object detector that detects peripheral mobile object detection information that is information regarding presence or absence of a mobile object around said probe vehicle, and
said transmitter transmits said peripheral mobile object detection information detected by said peripheral mobile object detector to outside said vehicle.
